(19) United States
(12) Patent Application Publication
(10) Pub. No.: US 2016/0368429 A1
(43) Pub. Date: Dec. 22, 2016

(54) VEHICLE MOUNTING SYSTEM

(71) Applicant: Havis, Inc., Warminster, PA (US)

(72) Inventors: Joseph Bernert, Hatboro, PA (US); Dave Enama, Jamison, PA (US); Michael Creighton, Hatboro, PA (US); Arthur Klotz, Willow Grove, PA (US); Ersen Boran, Cherry Hill, NJ (US)

(21) Appl. No.: 14/745,839

(22) Filed: Jun. 22, 2015

(51) Int. Cl. B60R 11/00

(52) U.S. Cl. CPC B60R 11/00; B60R 2011/0078; B60R 2011/0084; B60R 2011/0082

(57) ABSTRACT

Systems for mounting an object within a vehicle are disclosed. One system includes a housing, a pair of rotatable objects, a pair of locking elements, and at least one handle. Each rotatable object is at least partially received within a respective end of the housing. Each locking element is movable within the housing between a locked position in which the locking element exerts a locking force against a respective rotatable object, and an unlocked position in which the locking element does not exert the locking force against the respective rotatable object. The handle extends from the housing. The handle is coupled to one or both of the locking elements. The handle is configured to be actuated to move the one or both of the locking elements between the locked and unlocked positions.

### FIELD OF THE INVENTION

The present invention relates generally to mounting systems, and more particularly, to systems for repositionably mounting objects within a moving vehicle.

### BACKGROUND OF THE INVENTION

Specialized vehicles are an essential tool in many different professions. In particular, professions such as law enforcement commonly utilize a number of specialized electronic systems (e.g., computers, radio systems, sirens) that are not found in conventional automobiles. While vehicles may be specially manufactured that include these systems, these systems may also be added to conventional automobiles through after-market installations. However, one problem that arises from such installations is the simple and effective mounting of after-market electronic devices in conventional vehicles. Improved systems are desired for repositionably mounting objects in vehicles.

### SUMMARY OF THE INVENTION

Aspects of the present invention are directed to systems for mounting an object within a vehicle.

In accordance with one aspect of the present invention, a system for mounting an object within a vehicle is disclosed. The system includes a housing, a pair of rotatable objects, a pair of locking elements, and at least one handle. The housing has opposed ends. Each rotatable object is at least partially received within a respective one of the opposed ends of the housing. The pair of locking elements are positioned within the housing. Each locking element is movable within the housing between a locked position in which the locking element exerts a locking force against a respective rotatable object to resist rotation of the rotatable object relative to the housing, and an unlocked position in which the locking element does not exert the locking force against the respective rotatable object, and the rotatable object is free to rotate relative to the housing. The handle extends from the housing. The handle is coupled to one or both of the locking elements. The handle is configured to be actuated to move the one or both of the locking elements between the locked and unlocked positions.

In accordance with another aspect of the present invention, another system for mounting an object within a vehicle is disclosed. The system includes a housing, a pair of rotatable objects, and at least one handle. The housing has a pair of housing shells configured to mate with one another. Each housing shell has a pair of locking portions rigidly formed on opposed ends thereof. Each rotatable object is received between a respective one of the pair of locking portions of one of the pair of housing shells and a corresponding one of the pair of locking portions of the other one of the pair of housing shells. The handle extends from and is coupled to the housing. The handle is configured to be actuated to move the pair of housing shells between a locked position in which the pair of housing shells are pressed together and each locking element exerts a locking force against a respective rotatable object to resist rotation of the rotatable object relative to the housing, and an unlocked position in which the pair of housing shells are spaced apart and each locking element does not exerts the locking force against a respective rotatable object, and the rotatable object is free to rotate relative to the housing.

### BRIEF DESCRIPTION OF THE DRAWINGS

The invention is best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be dropped. This emphasizes that according to common practice, the various features of the drawings are not drawn to scale unless otherwise indicated. On the contrary, the dimensions of the various features may be expanded or reduced for clarity. Included in the drawings are the following figures:

FIG. 1 is a perspective view of an exemplary system for mounting an object within a vehicle in accordance with aspects of the present invention;

FIG. 2 is a perspective view of the system of FIG. 1 with a housing shell removed;

FIGS. 3A and 3B are exploded view of embodiments of the system of FIG. 1;

FIGS. 4A and 4B are perspective and cross-sectional views, respectively, of an exemplary ball mount of the system of FIG. 1;

FIGS. 4C and 4D are views of an exemplary mounting surface of the system of FIG. 1;

FIG. 5 is a perspective view of an exemplary sleeve of FIG. 1;

FIG. 6 is an image of an alternative exemplary system for mounting an object within a vehicle in accordance with aspects of the present invention;

FIG. 7 is an exploded view of the system of FIG. 6;

FIG. 8 is an image of another alternative exemplary system for mounting an object within a vehicle in accordance with aspects of the present invention; and

FIG. 9 is an exploded view of the system of FIG. 8.

### DETAILED DESCRIPTION OF THE INVENTION

The systems disclosed herein are usable to provide mounting for objects within conventional vehicles (such as automobiles). While the disclosed systems are described herein with respect to mounting within the cabin of a vehicle, it will be understood that the invention is not so limited. To the contrary, aspects of the present invention are usable in any application in which a repositionable mount is desired.

While any objects may be mounted within the disclosed systems, the disclosed mounting systems are particularly suitable for mounting electronic devices, such as laptops, tablets, or mobile phones. Such devices may be subject to periodic use within the vehicle, and as such, the disclosed systems advantageously allow such objects be repositioned between a “use” and “stow” position while remaining mounted to a portion of the vehicle. Other electronic devices or objects mountable with the disclosed systems will be known to those of ordinary skill in the art from the description herein.

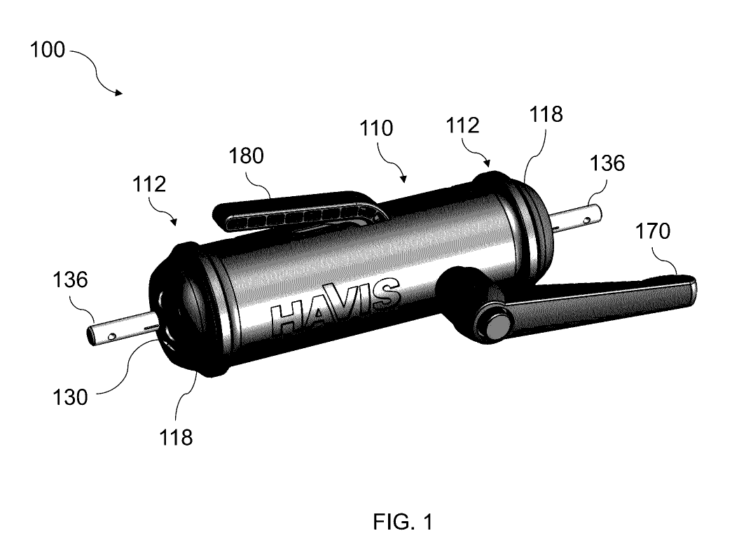

With reference to the drawings, FIG. 1 illustrates an exemplary system 100 for mounting an object within a vehicle in accordance with aspects of the present invention. System 100 is usable to repositionably mount objects, such that they can be moved within various stable positions within a vehicle. In general, system 100 includes a housing 110, a pair of rotatable objects 130, a pair of locking elements 150, and a handle 170. Additional details of system 100 are provided herein.

Housing 110 houses the components of system 100. Housing 110 has a pair of opposed ends 112 on either side of an elongated body. The elongated shape of housing 110 provides distance between the mounting surface and the object to be mounted. When installed, one end 112 of housing 110 is positioned adjacent the mounting surface, and the other end 112 of housing 110 is positioned adjacent the object being mounted.

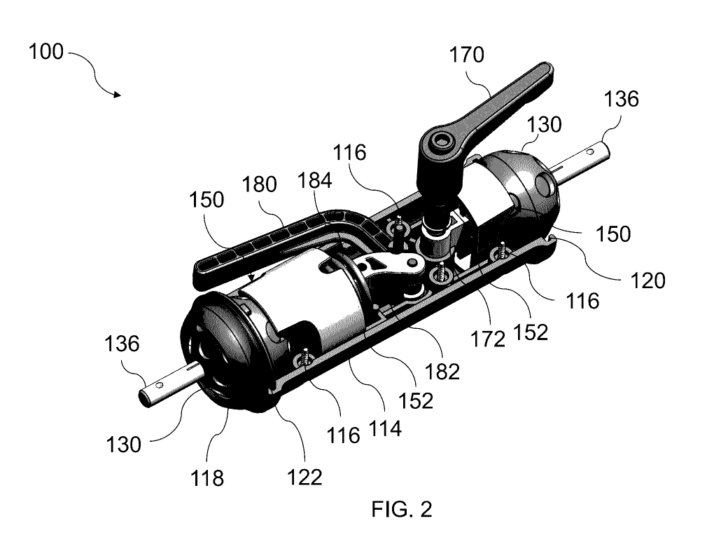

In an exemplary embodiment, housing 110 has a cylindrical shape, as shown in FIG. 1. The housing 110 comprises a pair of hemicylindrical housing shells 114 which are mated to one another to form the housing. Housing shells 114 may be mated to one another, for example, by screws, bolts, or friction fitting. In an exemplary embodiment, one of the housing shells 114 includes a plurality of screws 116 for attaching to the other housing shell 114, as shown in FIG. 2. Housing shells 114 may include one or more openings for accommodating handle 170, as will be described in greater detail below.

Housing 110 may also include an annular collar 118 affixed to each end 112. Collars 118 maintain the pair of rotatable objects 130 within the ends 112 of housing 110. Collars 118 have a smooth inner surface which is shaped to match the contour of the pair of rotatable objects 130. As a result, collars 118 do not block rotation of objects 130 within housing 110.

Collars 118 have an annular shape to provide an opening for connecting the rotatable object 130 to either the mounting surface or the object to be mounted. The opening in collars 118 defines the range of rotation of each rotatable object 130, as will be described below. Accordingly, collars 118 may desirably be thin, or have a large opening, in order to increase the rotation range of system 100.

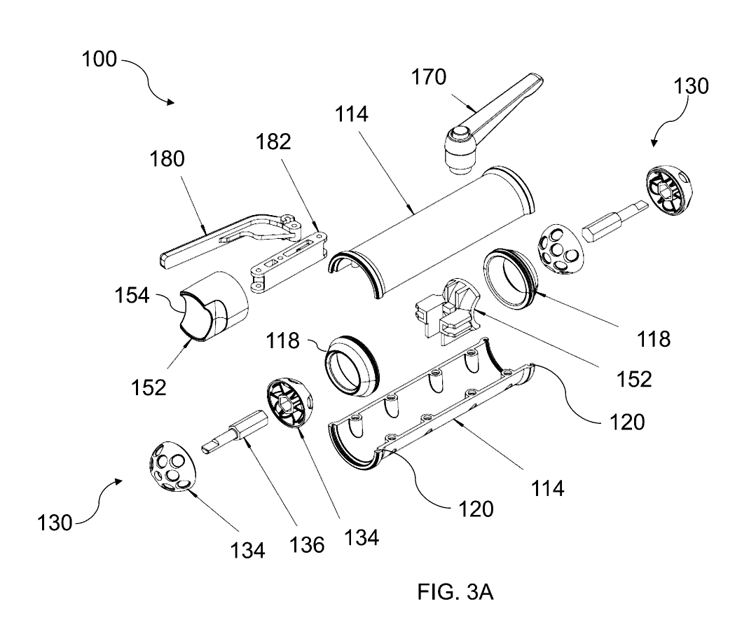

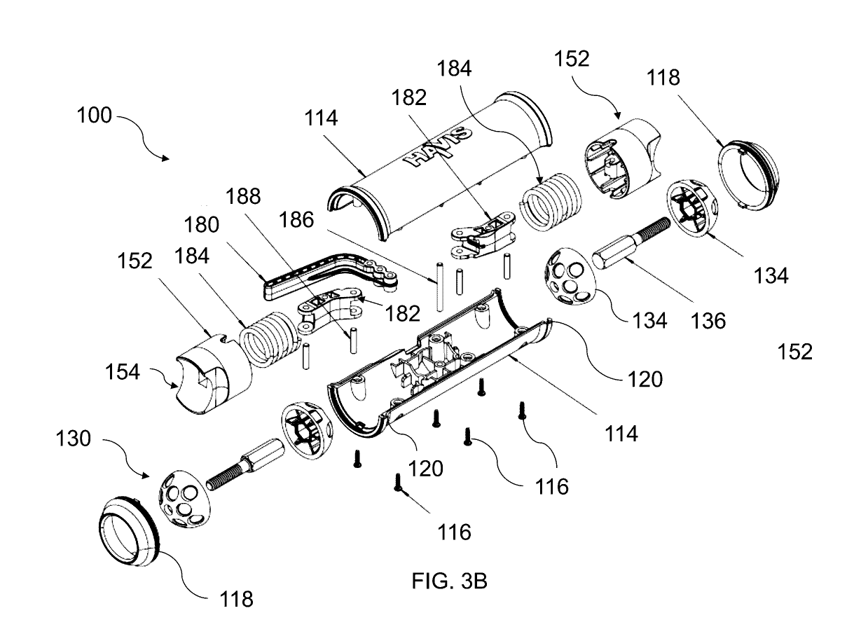

In an exemplary embodiment, housing shells 114 form an annular groove 120 when assembled to form housing 110, as shown in FIGS. 3A and 3B. Collars 118 include an annular ridge 122 which may be received within groove 120 in housing 110 in order to secure collars 118 to housing 110. Other ways of affixing collars 118 to housing 110, such as a friction fit, will be known to those of ordinary skill in the art from the description herein.

While collars 118 are described as separate components, it will be understood that the invention is not so limited. In an alternative embodiment, collars 118 may be integrally formed with respective housing shells 114, in order to maintain rotatable objects 130 within housing 110.

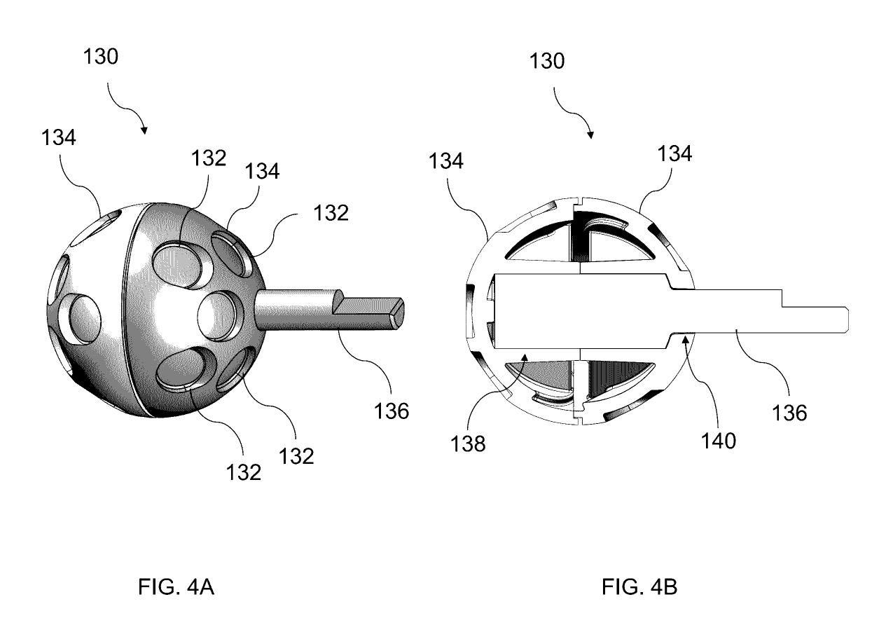

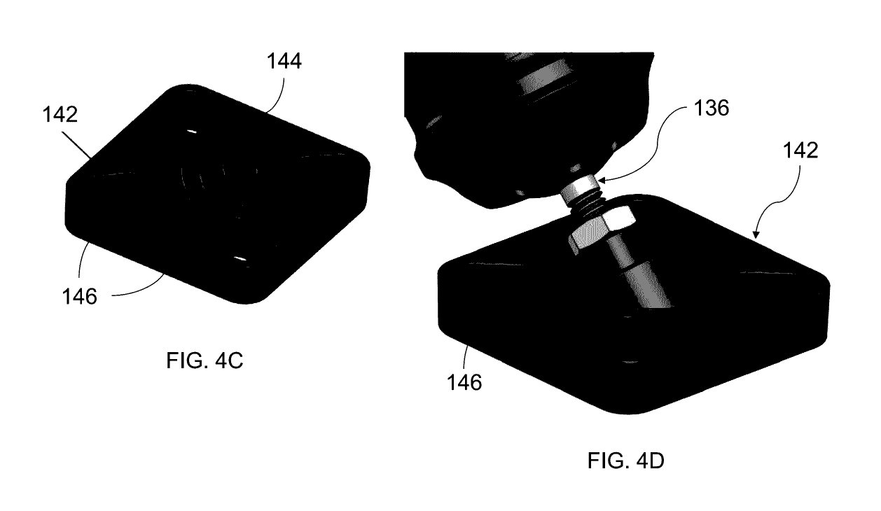

The pair of rotatable objects 130 are at least partially received within ends 112 of housing 110. Objects 130 are rotatable within housing 110 during repositioning of the mounted object. Additional details of rotatable objects 130 are described with respect to the exemplary embodiment shown in FIGS. 4A and 4B.

In an exemplary embodiment, each rotatable object 130 has a spherical shape, and is referred to herein as a ball. In a preferred embodiment, each ball has a plurality of dimples 132 formed in its surface. The size, spacing, and shape of dimples 132 shown in FIG. 4A is provided for the purposes of illustration, and is not intended to be limiting. For example, dimples 132 may be separated by portions of the spherical surface of the ball, or may completely cover the surface of the ball.

As shown in FIG. 4B, rotatable object 130 may comprise a pair of hemispherical shells 134 which are mated to one another to form the rotatable object 130. Hemispherical shells 134 may be mated to one another, for example, by screws, bolts, or friction fitting.

Each rotatable object 130 has a mating structure 136 extending therefrom. Mating structure 136 is configured to be attached to either the mounting surface of the vehicle or the object to be mounted. For example, mating structures 136 may comprise threading, screws, bolts, or keyed projections sized to mate with corresponding apertures on the mounting surface or mounted object. System 100 may include one or more additional components (not shown) for attaching mating structures 136 to either the mounting surface or the mounted object. Additionally, while mating structures 136 are described as extending from rotatable objects 130, it will be understood that mating structures 136 may be formed as openings in rotatable objects 130, into which a corresponding projection on either the mating surface or mounted object can be inserted.

Shells 134 may define an interior space 138 for accommodating a portion of mounting structure 136. In this embodiment, one of shells 134 may include an opening 140 for allowing the mating structure 136 to extend outward from rotatable object 130. Mating structure 136 includes a portion extending through opening 140 and portion positioned within space 138 that is larger than opening 140.

In a further embodiment, opening 140 in shell 134 is sized or shaped to prevent rotation of mating structure 136 relative to rotatable object 130. For example, mating structure 136 may have a hexagonal cross-section that is keyed to opening 140 to prevent rotation of mating structure 136 within rotatable object 130. This advantageously prevents the mounted object from rotating relative to rotatable object 130 after being mounted to system 100.

Mating structure 136 may be configured to be attached to exemplary mounting surface 142, as shown in FIGS. 4C and 4D. Mounting surface 142 includes an opening 144 configured to be coupled to mounting structure 136. In a preferred embodiment, opening 144 is a threaded opening configured to receive threading formed on mounting structure 136, as shown in FIG. 4D. Mounting surface 142 may further include one or more attachment points 146 configured to be attached (either directly or indirectly) to the object to be mounted.

The pair of locking elements 150 is positioned within housing 110. Locking elements 150 are usable to selectively lock the position of rotatable objects 130 relative to housing 110. In particular, locking elements 150 are movable within housing 110 between a locked position and an unlocked position. In the locked position, each locking element 150 exerts a locking force against a respective rotatable object 130 to resist rotation of rotatable object 130 relative to housing 110. In the unlocked position, locking element 150 does not exert the locking force against its respective rotatable object 130, and rotatable objects 130 are able to rotate more freely relative to housing 110. When the locking force is applied, the rotatable object is effectively fixed within locking element. Conversely, when the locking force is removed, the rotatable object is no longer fixed within the locking element. The locking force may be selected to prevent objects supported by the mounting system from moving relative to a vehicle during their intended use. When the locking force is removed, the force may be completely removed to enable free rotation of the rotatable object relative to the locking element or the force may be partially removed to enable rotation, but with some friction to facilitate positioning. Suitable locking forces will be understood by one of skill in the art from the description herein.

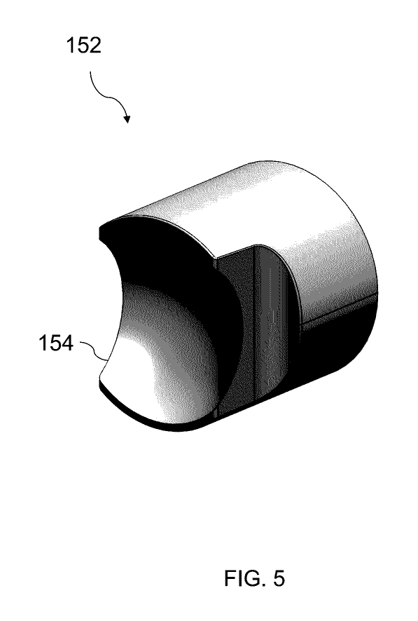

In an exemplary embodiment, each locking element 150 comprises a sleeve 152. Sleeves 152 are movable along the longitudinal axis of housing 110 between the locked and unlocked positions. An exemplary sleeve 152 is shown in FIG. 5. Sleeve 152 comprises a partially spherical surface 154. Sleeve 152 is provided within housing 110 such that surface 154 faces rotatable object 130. When sleeve 152 is in the locked position, surface 154 presses against the rotatable object 130.

In a preferred embodiment, either surface 154 of sleeve 152 or the surface of rotatable object 130 is covered with a compressible material. The compressible material may be a compressible rubber material or other material adapted to create friction between sleeve 152 and rotatable object 130. The friction between these objects prevents rotation of rotatable object 130 relative to housing 110, and immobilizes the mounted object in the desired position.

Handle 170 extends outward from housing 110. Handle 170 may be coupled to one or both of locking elements 150, and is provided for moving the associated locking element(s) 150. In particular, handle 170 can be actuated to move the associated locking element(s) 150 between the locked and unlocked positions.

Handle 170 may be directly coupled to the associated locking element(s) 150, or may be coupled to locking element(s) 150 indirectly (e.g., through one or more linking elements). The linking elements are structured to transmit the force from the actuation of handle 170 to locking element(s) 150, as described below.

As shown in FIG. 3A, system 100 may comprise a pair of handles 170 and 180. In this exemplary embodiment, handles 170 and 180 are coupled to respective locking elements 150. Alternatively, one of the handles 170 or 180 may be coupled to move a single locking element 150, while the other handle 180 or 170 is coupled to move both locking elements.

In an exemplary embodiment, handle 170 is actuated by rotating handle 170 between a first and second position. Handle 170 is coupled to a cam 172 that rotates along with handle 170, as shown in FIG. 2. In the first position, cam 172 engages with a cam surface on a sleeve 152 to force sleeve 152 against its respective rotatable object 130. Accordingly, in the first position, handle 170 moves locking element 150 to be in the locked position. Upon rotation of handle 170 to the second position, cam 172 slides off of the cam surface on sleeve 152, allowing sleeve 152 to move away from rotatable object 130. Accordingly, in the second position, handle 170 allows locking element 150 to be in the unlocked position. Locking element 150 may include a biasing element (not shown) such as a spring to force sleeve 152 into the unlocked position when handle 170 is rotated to be in the second position.

In an exemplary embodiment, handle 180 is biased outward from housing 110. Handle 180 is coupled to a linkage 182, as shown in FIG. 2. Linkage 182 is connected on one end to handle 180 and on the opposite end to a sleeve 152, in order to transmit the force from actuating handle 180 to sleeve 152. In the first position, a spring 184 biases sleeve 152 against its respective rotatable object 130. the bias applied by spring 184 is transmitted from sleeve 152 through linkage 182 to handle 180, thereby biasing handle 180 outward from housing 110. Accordingly, when handle 180 is biased outward from housing 110, locking element 150 is in the locked position. When handle 180 is squeezed or pressed toward housing 110, linkage 182 is pulled along the longitudinal axis of housing 110 away from rotatable object 130. Linkage 182 pulls sleeve away from rotatable object 130, against the bias applied by spring 184. Accordingly, in this second, squeezed position, handle 180 moves locking element 150 to the unlocked position.

As shown in FIG. 3B, system 100 may comprise a single handle 180. In this exemplary embodiment, handle 180 is coupled to move both locking elements 150.

In an exemplary embodiment, handle 180 is biased outward from housing 110. Handle 180 is coupled to a pair of linkages 182, as shown in FIG. 3B. Linkages 182 are connected on one end to handle 180 and on the opposite end to respective sleeves 152, in order to transmit the force from actuating handle 180 to sleeves 152. In the first position, springs 184 bias sleeves 152 against their respective rotatable objects 130. The bias applied by springs 184 is transmitted from sleeves 152 through linkages 182 to handle 180, thereby biasing handle 180 outward from housing 110. Accordingly, when handle 180 is biased outward from housing 110, locking element 150 is in the locked position. When handle 180 is squeezed or pressed toward housing 110, handle rotates around axis 186, and linkages 182 are pulled along the longitudinal axis of housing 110 away from rotatable object 130. Alternatively, linkages 182 may rotate around one or more axes 188 within housing 110 under force from handle 180. In either case, linkages 182 pull sleeves 152 away from rotatable objects 130, against the bias applied by springs 184. Accordingly, in this second, squeezed position, handle 180 moves locking elements 150 to the unlocked position.

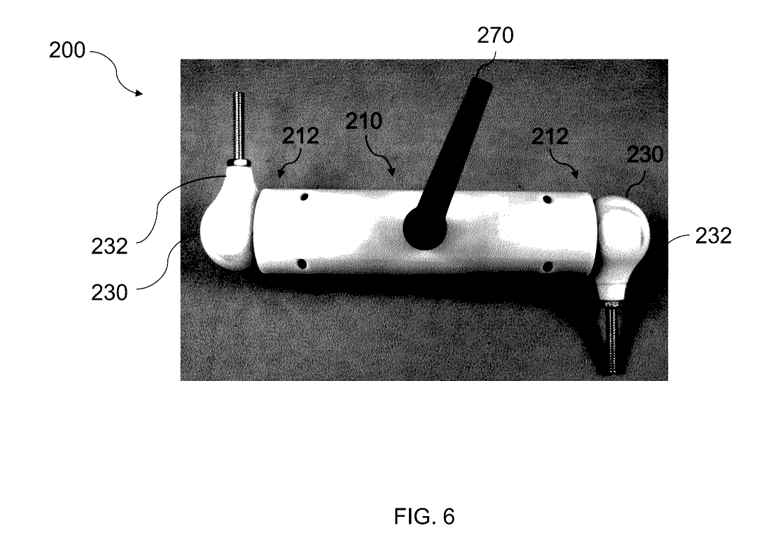

FIG. 6 illustrates another exemplary system 200 for mounting an object within a vehicle in accordance with aspects of the present invention. System 200 is also usable to repositionably mount objects, such that they can be moved within various stable positions within a vehicle. In general, system 200 includes a housing 210, a pair of rotatable objects 230, a pair of locking elements 250, and a handle 270. The components of system 200 correspond to those described above with respect to system 100, except as described below.

Housing 210 is formed from hemicylindrical housing shells 214. The pair of rotatable objects 230 have a small portion thereof which is received within ends 212 of housing 210, as shown in FIG. 6. Housing 210 does not require a collar for maintaining rotatable objects 230 within ends 212 thereof. To the contrary, a portion of locking element 250 couples each rotatable object 230 to housing 210, as will be described below.

In an exemplary embodiment, each rotatable object 230 has a spherical shape, and is referred to herein as a ball. In a preferred embodiment, each ball has a protrusion 232 extending outward from thereof and away from housing 210. The size and shape of protrusion shown in FIG. 6 is provided for the purposes of illustration, and is not intended to be limiting.

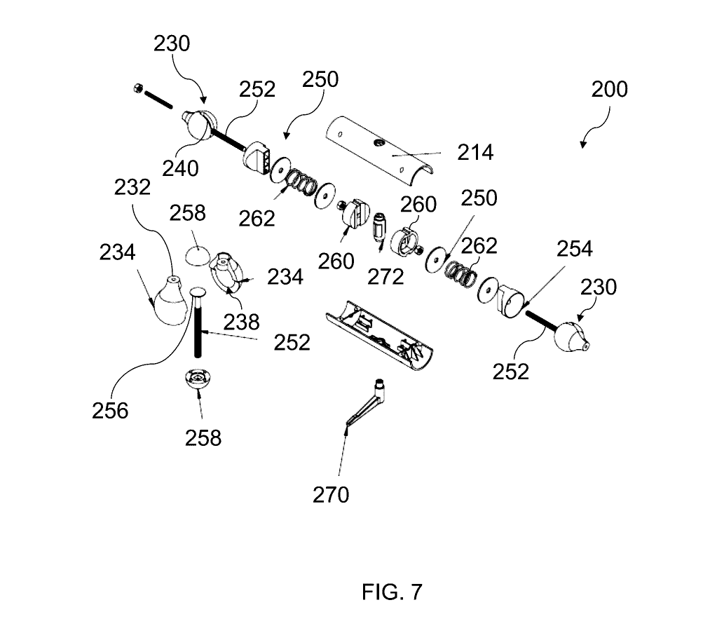

As shown in FIG. 7, rotatable object 230 may comprise a pair of hemispherical shells 234 which are mated to one another to form the rotatable object 230. Hemispherical shells 234 may be mated to one another, for example, by screws, bolts, or friction fitting.

Each rotatable object 230 may have a mating structure extending therefrom. The mating structure preferably extends from the area of protrusion 232. Alternatively, rather than extending from protrusion 232, the mating structure may be formed as an opening in the apex of protrusion into which a corresponding projection on either the mating surface or mounted object can be inserted.

In an exemplary embodiment, shells 234 define an interior space 238 for accommodating a portion of locking element 250, as will be described below. In this embodiment, hemispherical shells 234 define a slot 240 that extends along a surface of rotatable object 230 opposite protrusion 232 when shells 234 are mated together. Slot 240 provides an area for connection with the portion of locking element 250 positioned in the interior space 238 of rotatable object 230.

The pair of locking elements 250 are positioned within housing 210. In an exemplary embodiment, each locking element 250 is a locking mechanism which comprises a bolt 252 and a locking surface 254. Bolts 252 are movable along the longitudinal axis of housing 210 between the locked and unlocked positions.

Each bolt 252 is coupled to a respective rotatable object 230. In an exemplary embodiment, bolt 252 extends through slot 240 of rotatable object 230. Bolt 252 has a head 256 positioned in the interior space 238 within rotatable object 230. The head 256 of bolt 252 is sized such that it cannot pass through slot 240. As a result, movement of bolt 252 along the longitudinal axis of housing 210 is transferred to rotatable object 230 by the head 256 of bolt 252 bearing against the inner surface of shells 234.

In a further embodiment, head 256 of bolt 252 is integrally formed as or encases within an at least partial sphere 258, as shown in FIG. 7. Likewise, the interior space 238 of rotatable object 230 has an at least partially spherical shape which is sized to rotate along the surface of the partially sphere 258 of bolt 252. This spherical engagement between bolt 252 and rotatable object 230 enables rotatable object 230 to freely rotate relative to bolt 252. Rotatable object 230 is confined to rotate along the plane defined by slot 240, in such a manner that bolt 252 rides in slot 240 during rotation of object 230.

Surface 254 is a partially spherical surface 254. Surface 254 is fixed in place within housing 210 such that surface 254 faces rotatable object 230. When bolt 252 is in the locked position, surface 254 presses against the rotatable object 230. In a preferred embodiment, either surface 254 or the surface of rotatable object 230 is covered with a compressible material, as described above with respect to system 100. The friction between surface 254 and rotatable object 230 caused by this compressible material prevents rotation of rotatable object 230 relative to housing 210, and immobilizes the mounted object in the desired position.

In an exemplary embodiment, each bolt 252 extends from the head 256 within rotatable object 230 through the respective locking surface 254. The end of bolt 252 opposite head 256 is coupled to a respective retainer 260 positioned on an opposite side of surface 254 than rotatable object 230. Like bolt 252, retainer 260 is movable along the longitudinal axis of housing 210. Retainer 260 can be moved away from surface 254 in order to pull bolt 252 through surface 254 and press the respective rotatable object 230 coupled to bolt 252 against locking surface 254 when the locking element 250 is in the locked position. Each locking element 250 may further comprise a biasing element 262 positioned to bias a respective retainer 260 away from surface 254 to be in the locked position.

Handle 270 is coupled to both locking elements 250, and can be actuated to move the associated components of locking elements 250 between locked and unlocked positions. Handle 270 may be directly coupled to the associated locking elements 250, or may be coupled to locking elements 250 indirectly (e.g., through one or more linking elements).

While system 200 is illustrated as including a single handle 270, it will be understood that the invention is not so limited. To the contrary, system 200 may include one or two handles. If two handles are used, the handles may be coupled to the respective locking elements 250 in any of the manners described above with respect to system 100.

In an exemplary embodiment, handle 270 is actuated by rotating handle 270 between a first and second position. Handle 270 is coupled to a pair of cams 272 that rotate along with handle 270, as shown in FIG. 6. In the first position, cams 272 engage with a cam surface on each retainer 256 to force the retainers 256 outward against the bias applied by biasing element 262. This moves bolts 252 outward, moving rotatable objects 230 away from their respective locking surfaces 254. Accordingly, in the first position, handle 270 moves locking elements 250 to be in the unlocked position. Upon rotation of handle 270 to the second position, cams 272 slide off of the cam surfaces on retainers, allowing retainers 256 to move away from surfaces 254 under bias by biasing elements 262. This movement pulls bolt 252 inward, pressing rotatable object 230 against locking surface 254. Accordingly, in the second position, handle 270 allows locking element 250 to be in the locked position.

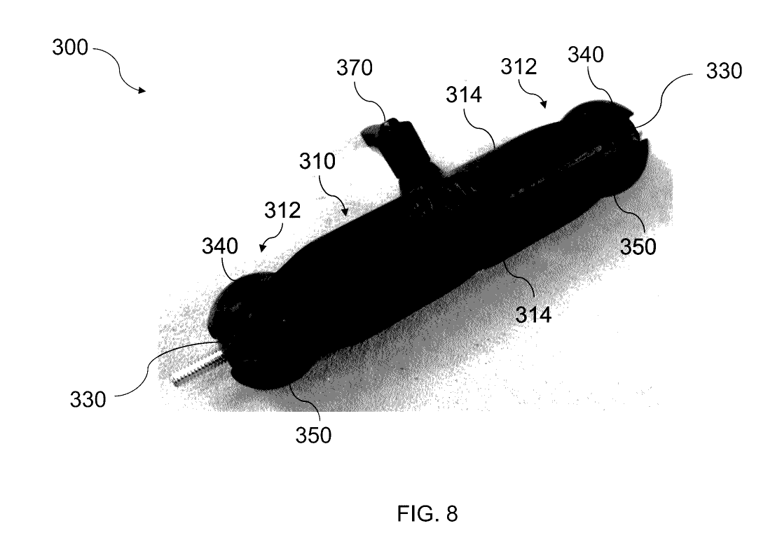

FIG. 8 illustrates yet another exemplary system 300 for mounting an object within a vehicle in accordance with aspects of the present invention. System 300 is also usable to repositionably mount objects, such that they can be moved within various stable positions within a vehicle. In general, system 300 includes a housing 310, a pair of rotatable objects 330, and a handle 370. The components of system 300 correspond to those described above with respect to system 100, except as described below.

Housing 310 comprises a pair of hemicylindrical housing shells 314 which are mated to one another to form the housing. Each housing shell 314 has a pair of locking portions 350 rigidly formed on opposed ends 312 thereof. Each of the rotatable objects 330 is received between the one of the locking portions 350 on one housing shell 314 and one of the locking portions 350 on the other housing shell 314.

In an exemplary embodiment, each locking portion 350 comprises a partially spherical surface 354. Each surface 354 is rigidly coupled to a respective housing shell 314 such that surface 354 faces rotatable object 330. When housing shells 314 are in the locked position, surface 354 presses against the rotatable object 330. In a preferred embodiment, either surface 354 or the surface of rotatable object 330 is covered with a compressible material, as described above with respect to system 100. The friction between surface 354 and rotatable object 330 caused by this compressible material prevents rotation of rotatable object 330 relative to housing 310, and immobilizes the mounted object in the desired position.

When housing shells 314 are in the locked position, locking portions 350 on each shell 314 define a slot 340 therebetween. Slots 340 extends around each end 312 of housing 310. Rotatable objects 330 are confined to rotate along the path defined by slot 340.

Handle 370 is coupled to both housing shells 314. Handle 307 can be actuated to move the housing shells 314 between locked and unlocked positions.

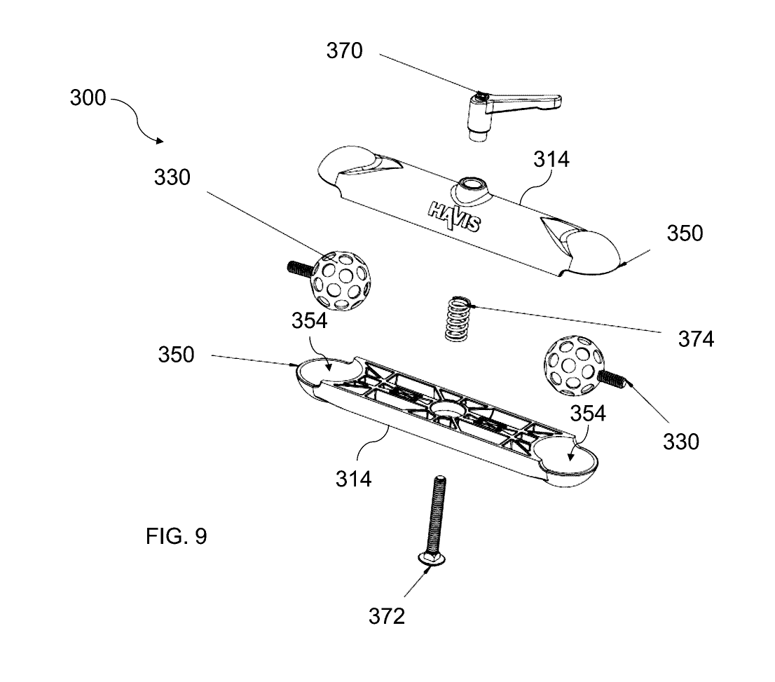

In an exemplary embodiment, handle 370 is actuated by rotating handle 370 between a first and second position. Handle 370 extends from one of the pair of housing shells 314, and is coupled to a screw 372 which is inserted through the other housing shell 314, as shown in FIG. 9. In the first position, handle 370 pulls screw 372 toward the opposite housing shell 314 against the force of a biasing element 374 within housing 310. This may be done, for example, by providing a cam on handle 370 that abuts the outer surface of the housing shell 314 from which handle 370 extends. Pulling screw 372 presses housing shells 314 together, thereby pressing surface 354 of each locking portion 350 against the respective rotatable objects 330. Accordingly, in the first position, handle 370 moves housing shells 314 to be in the locked position. Upon rotation of handle 370 to the second position, screw 372 is released outward from the opposite housing shell 314. Biasing element 374 within housing 310 moves housing shells 314 a predetermined distanced apart from one another, such that rotatable objects 330 are free to rotate in the space between locking portions 350. The predetermined distance may be defined by contact between screw 372 and handle 370. Accordingly, in the second position, handle 370 allows housing shells 314 to be in the unlocked position.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A system for mounting an object within a vehicle comprising:
a housing having opposed ends;
a pair of rotatable objects, each rotatable object at least partially received within a respective one of the opposed ends of the housing;
a pair of locking elements positioned within the housing, each locking element movable within the housing between a locked position in which the locking element exerts a locking force against a respective rotatable object to resist rotation of the rotatable object relative to the housing, and an unlocked position in which the locking element does not exert the locking force against the respective rotatable object, and the rotatable object is free to rotate relative to the housing; and
at least one handle extending from the housing, the at least one handle coupled to one or both of the locking elements, the at least one handle configured to be actuated to move the one or both of the locking elements between the locked and unlocked positions.

2. The system of claim 1, wherein the housing is a cylindrical housing.

3. The system of claim 1, further comprising an annular collar affixed to each of the opposed ends of the housing, the collars maintaining the pair of rotatable objects within the opposed ends of the housing without blocking rotation of the pair of rotatable objects relative to the housing.

4. The system of claim 1, wherein the pair of rotatable objects are a pair of balls, each ball having a plurality of dimples formed in a surface thereof.

5. The system of claim 1, wherein each of the rotatable objects has a respective mating structure extending therefrom, the respective mating structure of each rotatable object configured to be attached to the vehicle or the object.

6. The system of claim 1, wherein the pair of locking elements comprises a pair of sleeves, each sleeve movable along a longitudinal axis of the housing between the locked and unlocked positions.

7. The system of claim 6, wherein each sleeve comprises a partially spherical surface positioned to press against the respective rotatable object when the sleeve is in the locked position.

8. The system of claim 7, wherein at least one of the partially spherical surface of the sleeve and a surface of the rotatable object comprises a compressible rubber layer.

9. The system of claim 1, wherein the at least one handle is biased outward from the housing, and the handle is actuatable by squeezing or pressing the handle toward the housing to move the one or both of the locking elements.

10. The system of claim 1, wherein the at least one handle is actuatable by rotating the handle between a first position in which the one or both of the locking elements are in the locked position and a second position in which the one or both of the locking elements are in the unlocked position.

11. The system of claim 1, wherein the at least one handle comprises a pair of handles, each handle coupled to a respective locking element.

12. The system of claim 1, wherein the pair of rotatable objects comprise a pair of balls, each ball having a protrusion extending away from the housing.

13. The system of claim 12, wherein each ball has a mating structure extending outward from the protrusion, the mating structure configured to be attached to the vehicle or the object.

14. The system of claim 12, wherein the pair of locking elements comprises a pair of locking mechanisms, each locking mechanism comprising a bolt and a locking surface, the bolt coupled to a respective ball and movable along a longitudinal axis of the housing between the locked and unlocked positions.

15. The system of claim 14, wherein each bolt extends through the locking surface and is coupled to a respective retainer which is movable along the longitudinal axis of the housing in order to press the respective ball against the respective locking surface when the locking mechanism is in the locked position.

16. The system of claim 15, wherein each locking mechanism further comprises a biasing element positioned to bias the retainer to be in the locked position, the at least one handle acting against the bias of the biasing element to move the retainer to the unlocked position.

17. The system of claim 14, wherein each ball comprises a slot in a surface thereof, the bolt extending through the slot and having a head positioned within the ball such that the head of the bolt cannot pass through the slot.

18. The system of claim 17, wherein the head of the bolt has an at least partially spherical shape, and the ball has an inner at least partially spherical surface size to rotate along an outer surface of the at least partially spherical bolt head.

19. The system of claim 14, wherein each locking surface comprises a partially spherical surface positioned to press against the respective ball when the locking mechanism is in the locked position.

20. The system of claim 14, wherein at least one of the locking surface and a surface of the ball comprises a compressible rubber layer.

21. The system of claim 14, wherein the at least one handle is actuatable by rotating the handle between a first position in which both of the locking mechanisms are in the unlocked position and a second position in which both of the locking mechanisms are in the locked position.

22. A system for mounting an object within a vehicle comprising:
a housing comprising a pair of housing shells configured to mate with one another, each housing shell having a pair of locking portions rigidly formed on opposed ends thereof;
a pair of rotatable objects, each rotatable object received between a respective one of the pair of locking portions of one of the pair of housing shells and a corresponding one of the pair of locking portions of the other one of the pair of housing shells;
at least one handle extending from and coupled to the housing, the at least one handle configured to be actuated to move the pair of housing shells between a locked position in which the pair of housing shells are pressed together and each locking element exerts a locking force against a respective rotatable object to resist rotation of the rotatable object relative to the housing, and an unlocked position in which the pair of housing shells are spaced apart and each locking element does not exerts the locking force against a respective rotatable object, and the rotatable object is free to rotate relative to the housing.

23. The system of claim 22, wherein the housing shells are hemicylindrical shells.

24. The system of claim 22, wherein the pair of rotatable objects are a pair of balls, each ball having a plurality of dimples formed in a surface thereof.

25. The system of claim 22, wherein each of the rotatable objects has a mating structure extending therefrom, the mating structure configured to be attached to the vehicle or the object.

26. The system of claim 22, wherein each locking element comprises a partially spherical surface positioned to press against the respective rotatable object when the housing shells are in the locked position.

27. The system of claim 26, wherein at least one of the partially spherical surfaces of the housing shells and a surface of the rotatable object comprises a compressible rubber layer.

28. The system of claim 26, wherein the partially spherical surfaces on each housing shell define a slot therebetween when the housing shells are in the locked position.

29. The system of claim 22, wherein the at least one handle is actuatable by rotating the handle between a first position in which the housing shells are in the locked position and a second position in which the housing shells are in the unlocked position.

30. The system of claim 22, further comprising a biasing element positioned to bias the housing shells to be in the unlocked position, the at least one handle acting against the bias of the biasing element to move the housing shells to the locked position.

31. The system of claim 22, further comprising at least one screw extending through at least one of the housing shells, the at least one screw mating the housing shells to one another while enabling movement of the housing shells between the locked and unlocked positions.
